(19) United States
(12) Patent Application Publication
(10) Pub. No.: US 2009/0258512 A1
(43) Pub. Date: Oct. 15, 2009

(54) IC SOCKET

(76) Inventors: Toshio Ohta, Tokyo (JP); Shinichiro Nakamura, Tokyo (JP)

Correspondence Address: 3M INNOVATIVE PROPERTIES COMPANY, PO BOX 33427, ST. PAUL, MN, 55133-3427, US

(21) Appl. No.: 12/374,036

(22) PCT Filed: Jul. 30, 2007
(86) PCT No.: PCT/US07/74745

§ 371 Date: Jan. 15, 2009

(30) Foreign Application Priority Data
Aug. 2, 2006 (JP) 2006-211224

(51) Int. Cl. H01R 12/00

(52) U.S. Cl. 439/78

(57) ABSTRACT

The object of the present invention is to provide an IC socket having a constitution for simplifying the motion of an activating member for operating a lever, whereby the operation of the lever may be easily applied to an automated machine. A lever member 35 having the bifurcated shape includes first and second legs 353 and 354. In the first position, the first leg 353 operably projects from the base 2 and the lid 3. On the other hand, the second leg 354 is contained in the lid 3. When the actuating member 5 is moved to rotate the lever member 35 from the first position to the second position, the first leg 353 is contained in the lid 3 and the second leg 354 operably projects from the base 2 and the lid 3.

### TECHNICAL FIELD

The present invention relates to an IC socket for electrically connecting a device for a semiconductor integrated circuit (hereinafter referred as “IC”), in particular, to a clamshell-type IC socket used for testing the IC device.

### BACKGROUND ART

Japanese Unexamined Utility Model Publication (Kokai) No. 2-148483 discloses one example of a clamshell-type IC socket for carrying out a burn-in test in which the electric characteristic, the durability and the heat resistance of an IC device are tested. The IC socket has a contact contacting the IC device, and the movement in the vertical direction of the contact is improved, whereby the sure electrical contact between the contact and the IC device may be achieved.

FIG. 7 is an external perspective view of an example of a conventional clamshell-type IC socket 100. The IC socket 100 has a base 102, a lid 103 pivotably attached to the base 102 and a latch 104 for retaining the lid 103 in a closed position relative to the base 102.

FIGS. 8(a) and (b) show a top view of the IC socket 100 of FIG. 7. The IC socket 100 has a lever 135 capable of pivoting about generally the center of the IC socket. The lever 135 may move between a first position as shown in FIG. 8(a) and a second position as shown in FIG. 8(b). At this point, the first position corresponds to the state in which an object or an IC device to be tested (not shown) is not yet set, i.e., the object is not surely electrically connected to the IC socket 100. On the other hand, the second position corresponds to the state in which the object is surely electrically connected to the IC socket 100 and various tests may be carried out.

### SUMMARY

In the conventional clamshell-type IC socket as shown in FIGS. 7 and 8, the movement of the lever 135 may cause the relative displacement of a bearing of the lever to a slope arranged on a pushing member or a pusher plate. Accordingly, the IC device may be pressed against the contact by a low and vertical operation force. (This principle of operation is explained in the description regarding an embodiment of the invention.) However, when a plurality of IC sockets are aligned so as to automate the operation of the lever, the movement of an activating member of an automated machine for operating the lever becomes complicated. In other words, as shown in FIG. 8(b), an activating member 105 of the automated machine, schematically indicated by a circle, moves or pushes a leg 1353 of the lever 135 of the IC socket 100 from the first position to the second position. After that, as indicated by an arrow, the activating member 105 must get around the leg 1353 in order to return the lever 135 to the first position again. This operation is complicated and takes a time. Otherwise, if a lever of another IC socket (not shown) adjacent to the IC socket 100 (on the right-hand of the IC socket 100 in FIG. 8(b)) should be subsequently operated after the lever 135 is moved from the first position to the second position, the activating member 105 must also get around the leg 1353 of the lever 135. In both cases, the activating member 105 must get around the lever, which may cause a time loss in the automatic operation or increase of a cost of the automated machine.

The object of the present invention is thus to provide an IC socket having a constitution for simplifying the motion of the activating member for operating the lever, whereby the operation of the lever may be easily applied to the automated machine.

In order to achieve the object of the invention described above, Claim 1 presents an IC socket comprising: a base having a contact capable of being electrically connected to an IC device; a lid attached to the base and movable relative to the base; a pushing member arranged in the lid such that the pushing member may move toward or away from the base; and a lever member configured to move between a first position in which the lever member does not bias the pushing member against the base and a second position in which the lever member biases the pushing member against the base, wherein the lever member has first and second operating parts which are operated when the lever member should be moved between the first and second positions, the first operating part being configured to project from the base and the lid and to be positioned outside of the base or the lid relative to the second operating part at the first position, and the second operating part being configured to project from the base and the lid and to be positioned outside of the base or the lid relative to the first operating part at the second position.

Claim 2 presents an IC socket as described in claim 1, in which the first operating part is configured to be contained in the base or the lid at the second position, and the second operating part is configured to be contained in the base or the lid at the first position.

Claim 3 presents an IC socket as described in claim 1 or 2, in which the lever member has a bifurcated shape and each of the first and second operating parts corresponds to a leg of the bifurcated shape.

Claim 4 presents an IC socket as described in claim 3, in which the lever member is configured to pivot about an axis and between the first and second positions, and a pivoting angle of the lever member between the first and second positions is equal to or less than 45 degrees.

Claim 5 presents an IC socket as described in one of preceding claims, in which the IC socket further comprising a latch for retaining the lid in a closed position relative to the base, the lid having a surface inclined in relation to the direction of movement of the latch.

Due to the IC socket according to the present invention, the lever member may be operated only by the substantially reciprocating movement of the activating member or the like. Therefore, the test of the IC device may be easily automated and an automated machine therefor may be constructed at a low cost. In addition, the present invention may be also advantageously applied to a case in which a plurality of IC socket are tested.

The operation by the automated machine may be further surely carried out by configuring the first operating part to be contained in the base or the lid at the second position, and the second operating part to be contained in the base or the lid at the first position.

Concretely, the lever member may have a simple bifurcated shape and each of the first and second operating parts corresponds to a leg of the bifurcated shape.

Due to the lever member having the bifurcated shape, a pivoting angle of the lever member may be less than that of a lever member having only one leg of the prior art. Accordingly, wear between the lever member and another member sliding each other may be reduced and the lives of the members may be lengthened.

Regarding the operation of the latch for closing the IC socket, the latch may also be operated only by the substantially reciprocating movement of the activating member or the like. Therefore, the operation of the latch may also be easily automated.

### BRIEF DESCRIPTION OF THE DRAWINGS

FIG. 1 (a) and (b) are perspective views of a preferred embodiment of a clamshell-type IC socket according to the present invention, indicating closed and opened position of the IC socket, respectively.

FIG. 2 An exploded perspective view of the IC socket of FIG. 1.

FIG. 3 An exploded perspective view showing the detail of a lid of the IC socket.

FIG. 4 A cross-sectional view along a line A-A of FIG. 3.

FIG. 5 (a) and (b) are top views of the IC socket, indicating a lever member of the IC socket positioned at first and second positions, respectively.

FIG. 6 A view showing a modification of a latch of the IC socket.

FIG. 7 A perspective view of a conventional IC socket.

FIG. 8 (a) and (b) are top views of the conventional IC socket, indicating a lever member of the IC socket positioned at first and second positions, respectively.

### DETAILED DESCRIPTION

The present invention is described immediately below with reference to the accompanying drawings.

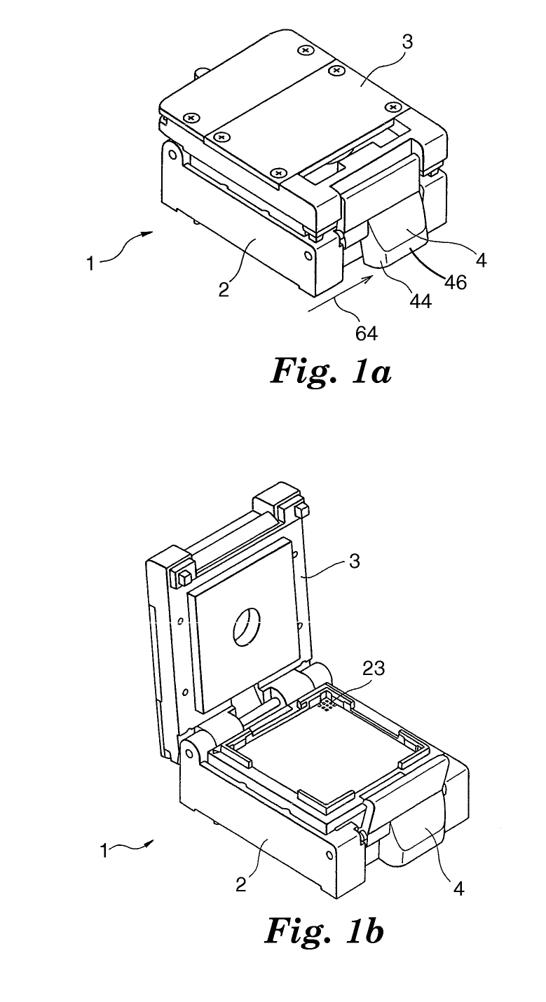

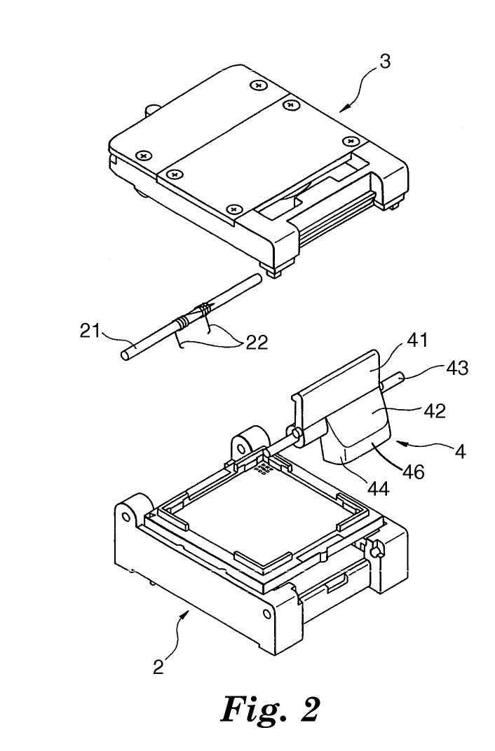

FIGS. 1(a) and (b) are perspective views of a preferred embodiment of a clamshell-type IC socket 1 according to the invention, indicating closed and opened positions of the IC socket, respectively. FIG. 2 is an exploded perspective view of the IC socket of FIG. 1. The IC socket 1 includes a base 2 placed on an inspection apparatus (not shown), a lid 3 pivotally attached to the base 2 by means of a hinge pin 21 and a torsion spring 22 as shown in FIG. 2, and a latch 4 for keeping the lid 3 closing the IC socket. The torsion spring 22 biases the lid 3 away from the base 2. Therefore, when the latch 4 does not engage the lid 3 (FIG. 1(b)), the lid 3 is opened and a not shown object to be tested or an IC device may be positioned on the base 2 such that the IC device contacts a contact 23 arranged on the base 2.

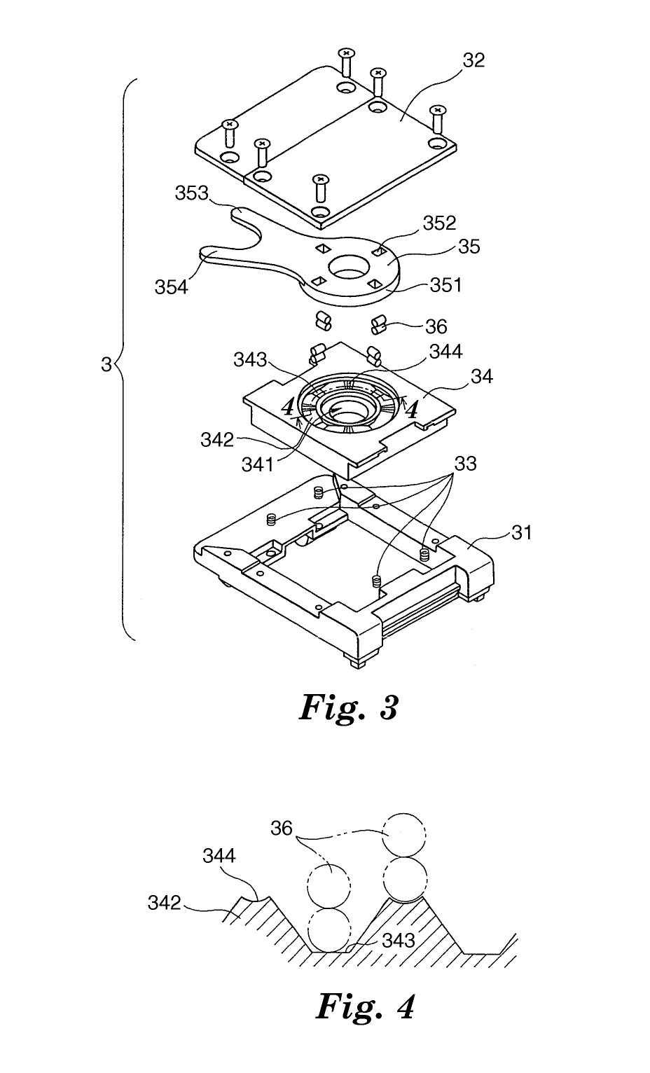

FIG. 3 is an exploded view indicating the detail of the lid 3. The lid 3 has a lid frame 31 and a cover 32 attached to an upper surface of the lid frame 31 by means of a spring or the like. A pushing member or a pusher plate 34 is arranged between the lid frame 31 and the cover 32, such that the pusher plate 34 is capable of being vertically displaced relative to the frame 31 by means of coil springs (in this case, four coil springs) 33. Also, a lever member 35 is arranged between the frame 31 and the cover 32 so as to displace the pusher plate 34. When the pusher plate 34 is vertically downwardly displaced, the pusher plate 34 pushes the not shown IC device against the contact 23 on the base 2, whereby the IC device may be surely electrically connected to the contact 23.

The lever member 35 has a discoidal pivoting part 351 engaging with a circular opening 341 formed on generally the center of the pusher plate 34. Therefore, the lever member 35 may be rotated about substantially one axis relative to the pusher plate 34. Further, on the discoidal pivoting part 351, receiving holes 352 each configured to receive a cylindrical roller bearing 36 are formed at a certain angular space (in this case, 90 degrees). On the other hand, the pusher plate 34 has an annular section 342 contacting the bearings 36. As shown in FIG. 4 indicating a cross-section along a line A-A of FIG. 3, the annular section 342 includes recesses 343 and projections 344 alternately formed at a certain angular space (in this case, 45 degrees). When each bearing 36 is positioned in each recess 343, as the pusher plate 34 is upwardly displaced relative to the frame 31 due to the biasing force of the coil springs 33, the object to be tested (or the IC device) is not surely electrically connected to the contact 23 (FIG. 1(b)) on the base 2. On the other hand, when each bearing 36 is positioned on each projection 344, as the pusher plate 34 is downwardly displaced relative to the frame 31 against the biasing force of the coil springs 33, the object to be tested is surely electrically connected to the contact 23 and is ready for the test. This principle of operation of the pusher plate 34 may be the same as a conventional technique.

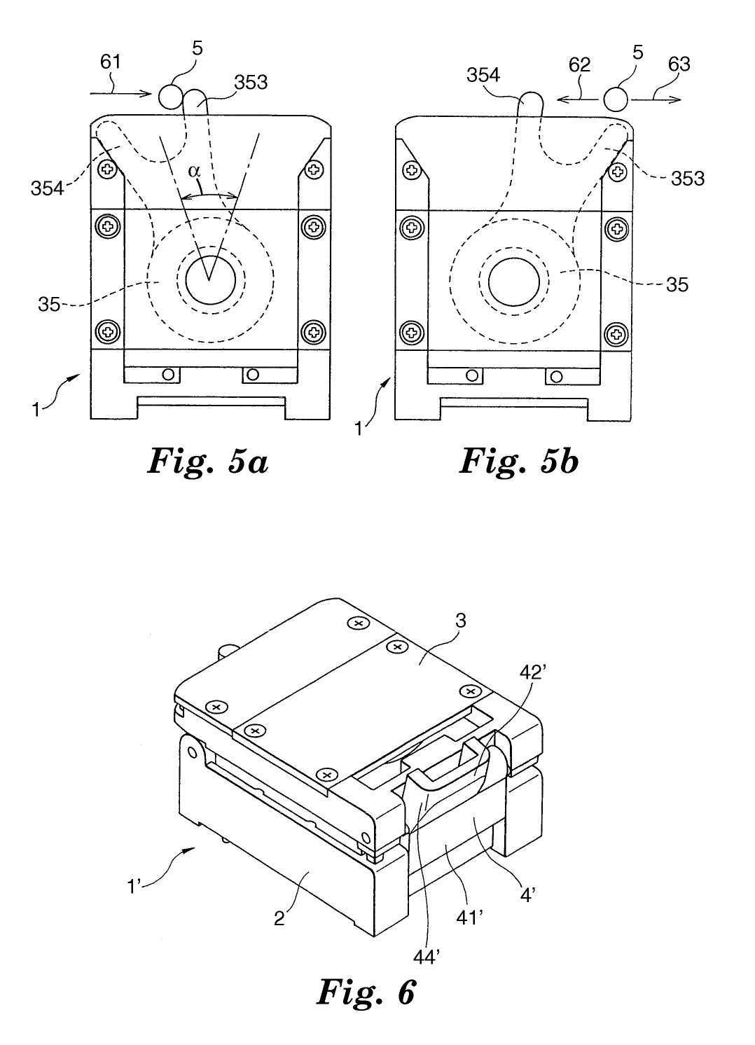

The present invention is characterized in that the lever member 35 has a bifurcated shape as shown in FIG. 3, so as to remarkably facilitate the operation of the lever by using an automated machine. This point is explained below with reference to FIGS. 5(a) and (b). Hereinafter, the position of the lever member 35 where each bearing 36 is positioned in each recess 343 of the annular section 342 is referred to as a first position, and the other position of the lever member 35 where each bearing 36 is positioned on each projection 344 of the annular section 342 is referred to as a second position. In addition, as shown in FIG. 4, a top surface of each projection 344 is preferably somewhat concaved. Due to this, the position of each bearing 36 relative to each projection 344 may be stable. Further, even when it is difficult to continuously contact an actuating member of the automated machine to the lever member 35 until the lever member 35 reaches to a target position (where each bearing 36 is positioned on generally the center of each projection 344), the lever 35 or the bearings 36 may be assisted to reach the target position on the annular section.

FIGS. 5(a) and (b) are top views of the IC socket 1, indicating the lever member 35 positioned at the first and second positions, respectively. In this embodiment, it is assumed that an actuating member 5 of the automated machine, schematically indicated by a circle, is used to rotate the lever member 35 between the first and second positions. The actuating member 5 is configured to be straightly reciprocated along arrows 61 and 62. As shown, the lever member 35 having the bifurcated shape includes first and second operating parts or legs 353 and 354. As shown in FIG. 5(a), in the first position, the first leg 353 operably projects from the base 2 and the lid 3. On the other hand, the second leg 354 is positioned inside the base 2 or the lid 3 relative to the first leg 353 and is preferably contained in the base 2 or the lid 3 (in this case, the lid 3). Therefore, when the actuating member 5 is moved along the arrow 61 relative to the IC socket 1 in order to rotate the lever member 35 from the first position to the second position (FIG. 5(b)), the actuating member 5 comes into contact with only the first leg 353.

When the lever member 35 reaches the second position (FIG. 5(b)) by movement of the actuating member 5 along the arrow 61, the second leg 354 operably projects from the base 2 and the lid 3, and the first leg 353 is positioned inside the base 2 or the lid 3 relative to the second leg 354 and is preferably contained in the base 2 or the lid 3 (in this case, the lid 3). Therefore, the actuating member 5 needs not to get around the lever member 35 as in the conventional case shown in FIG. 8(b), in order to move or return the lever member 35 to the first position again. In other words, the actuating member 5 is required to be simply returned along the arrow 62 opposing the arrow 61 so as to push the projecting second leg 354. Also, when a plurality of IC sockets are aligned along the arrow 61 so as to continuously operate levers of the IC socket by using the actuating member 5, the actuating member may access a lever member of another IC socket (not shown) positioned on the immediate right side of the IC socket 1 shown in FIG. 5(b), only by continuing the straight or linear movement along an arrow 63 without getting around the lever member. Accordingly, the actuating member of the automated machine is required to be reciprocated along substantially only one straight line, whereby the automated machine may have a simple configuration and may be constructed at low cost. Further, the operation time in using the automated machine may be reduced.

As apparent from the comparison between FIGS. 5 and 8, regarding the similar sized IC sockets, a pivoting angle of the lever member of the IC socket of the invention between the first and second positions may be less than that of the conventional IC socket. Concretely, the pivoting angle of the conventional IC socket is between about 60 and 90 degrees, as shown in FIG. 8(a). On the other hand, the pivoting angle of the IC socket of the invention may be equal to or less than about 45 degrees, as shown in FIG. 5(a). By reducing the pivoting angle, the sliding distance between the lever member 35 as shown in FIG. 3 and another member contacting the lever member may be shortened, whereby wear between them may be reduced and the lives of the members may be lengthened.

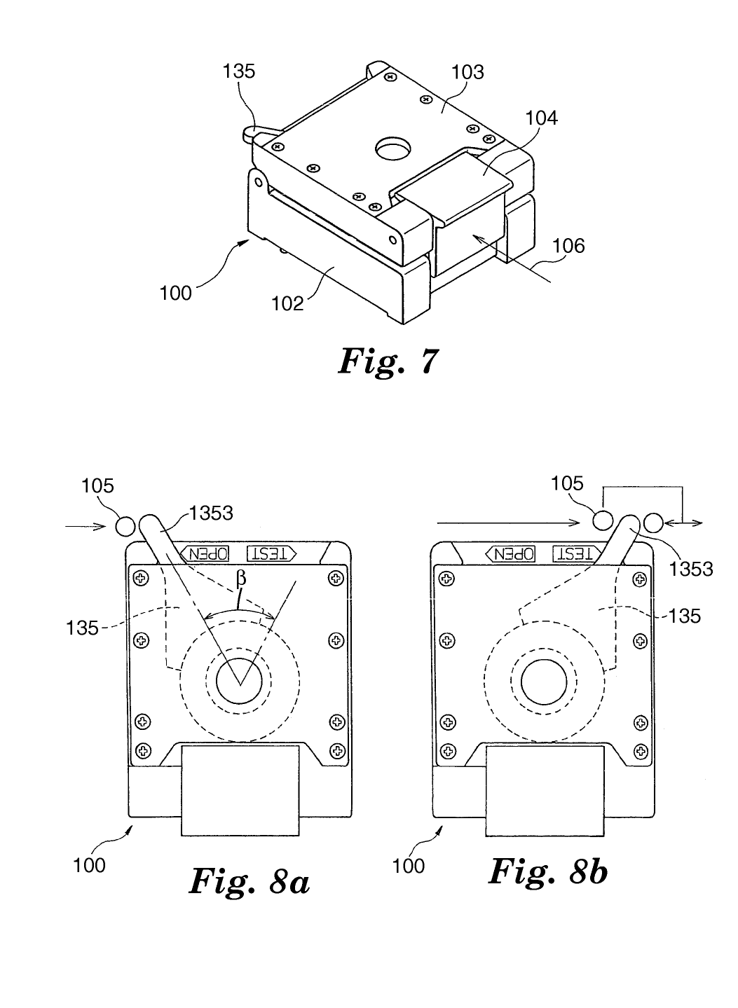

As described above, due to the IC socket having the lever member according to the invention, the motion required for the lever operation may be remarkably simplified and may be advantageously applied to an automated machine. On the other hand, regarding the motion of the latch 4 for opening or closing the lid 3, in the prior art as shown in FIG. 7, it is required to move an actuating member of the like along the direction which coincides with the direction of movement (as shown by an arrow 106) of an engaging portion of the latch. In particular, when latches of a plurality of IC sockets should be opened at the same time, an actuating member must be positioned close to each latch and moved in the direction of the arrow 106, which takes a long time. Hereinafter, the constitution for facilitating the automation of the releasing motion of the latch is explained.

With reference to FIG. 2 again, the latch 4 includes an engaging portion 41 for engaging with the lid 3 and an operating portion 42 operated by an automated machine. The engaging portion 41 and the operating portion 42 are integral with each other and configured to rotate about a hinge pin 43. At this point, the operating portion 42 has an operating surface or a curved surface 44 such that the latch 4 may be rotated by the motion of the actuating member of the automated machine in the direction of the arrow 64 as shown in FIG. 1(a). The curved surface 44 is inclined in relation to the direction of movement of the latch 4. Due to this constitution, by contacting an actuating member similar to the actuating member 5 to the curved surface 44 and subsequently moving the actuating member along a front face 46 of the latch 4 in the direction of the arrow 64, the operating portion 42 is rotated about the hinge pin 43 toward the base 2, and thus the engaging portion 41 is rotated away from the lid 3. As the actuating member may continue to be moved along the front face 46 of the latch 4 in the direction of arrow 64 after contacting the curved surface 44 without getting around the curved surface, the releasing motion of the latch may be carried out only by a simple linear motion of the actuating member. Further, when a plurality of IC sockets are aligned in the direction of the arrow 64, the latches of the IC sockets may be released only by the substantially linear motion of the actuating member. Therefore, the motion of the actuating member may be easily automated. In addition, the curved surface 44 may be a flat surface inclined in relation to the direction of the arrow 64.

FIG. 6 shows an IC socket 1′ having a latch 4′ which is a modification of the latch 4. The latch 4 as shown in FIG. 1 is attached to the base 2 and capable of engaging with the lid 3. On the other hand, the latch 4′ includes an engaging portion 41′ capable of engaging with the base 2 and an operating portion 42′ having an operated or inclined surface 44′ close to the lid 3. Also due to this constitution, one or more latch of one or more IC socket may be released only by the substantially linear motion of the actuating member.

1. An IC socket comprising:
a base having a contact capable of being electrically connected to an IC device;
a lid attached to the base and movable relative to the base;
a pushing member arranged in the lid such that the pushing member may move toward or away from the base; and
a lever member configured to move between a first position in which the lever member does not bias the pushing member against the base and a second position in which the lever member biases the pushing member against the base,
wherein the lever member has first and second operating parts which are operated when the lever member should be moved between the first and second positions, the first operating part being configured to project from the base and the lid and to be positioned outside of the base or the lid relative to the second operating part at the first position, and the second operating part being configured to project from the base and the lid and to be positioned outside of the base or the lid relative to the first operating part at the second position.

2. The IC socket as set forth in claim 1, wherein the first operating part is configured to be contained in the base or the lid at the second position, and the second operating part is configured to be contained in the base or the lid at the first position.

3. The IC socket as set forth in claim 1, wherein the lever member has a bifurcated shape and each of the first and second operating parts corresponds to a leg of the bifurcated shape.

4. The IC socket as set forth in claim 3, wherein the lever member is configured to pivot about an axis and between the first and second positions, and a pivoting angle of the lever member between the first and second positions is equal to or less than 45 degrees.

5. The IC socket as set forth in claim 1, further comprising a latch for retaining the lid in a closed position relative to the base, the lid having a surface inclined in relation to the direction of movement of the latch.
